(19) United States
(12) Patent Application Publication
(10) Pub. No.: US 2009/0117218 A1
(43) Pub. Date: May 7, 2009

(54) Apparatus for producing dope

(75) Inventors: Takuro Niishimura, Kanagawa (JP); Tadahiro Tsujimoto, Kanagawa (JP); Yukihiro Katai, Kanagawa (JP); Mitsuharu Kojima, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, TOKYO (JP)

(21) Appl. No.: 11/659,340

(22) PCT Filed: Jul. 28, 2005
(86) PCT No.: PCT/JP05/14258

§ 371 Date: Feb. 5, 2007

(30) Foreign Application Priority Data
Aug. 5, 2004 (JP) 2004-229679

(51) Int. Cl. B29C 41/24; B29C 41/34

(52) U.S. Cl. 425/144

(57) ABSTRACT

A dope (15) is prepared with using TAC as a polymer. The dope (15) is transferred with heated by a transferring device (30). A heating medium (36) is used to heat the dope in the transferring device (30). A passage (35) for the heating medium (36) is formed between a cylinder (31) and a jacket (34). The jacket (34) is attached to flanges (32), (33) so as to form a full jacket. When the heating medium (36) is fed in the full jacket, a temperature of the flanges (32), (33) becomes equal to a temperature of the cylinder (31). Accordingly, temperature profile of the dope (15) becomes small, because there is no low temperature portion in the transferring device (30). Therefore, gelatinous material, which is caused by association generated on the low temperature portion, is not in the dope (15).

### TECHNICAL FIELD

The present invention relates to an apparatus for producing dope, which is preferably used for solution casting method.

### BACKGROUND ART

A polymer is used in several manners. For example, a film is produced from cellulose acylate (hereinafter TAC) and used as a base film of a photosensitive material or a protective film for a polarizing filter in a liquid crystal display (LCD). As already known methods for producing the polymer film, there are a melt-extrusion method in which the polymer is melt with heating and an extrusion thereof is made to obtain the film, and a solution casting method in which a dope containing the polymer, a solvent and the like is prepared and the casting of the dope is made to obtain the film. The film obtained in the solution casting method is excellent in an optical isotropy and therefore used as an optical film (Japan Institute of Invention and Innovation (JIII) JOURNAL of Publication No. 2001-1745).

In a process for producing dope, it is possible that gelatinous material is occurred. The gelatinous material can be removed by filtering or by reapplying a dissolution process to the dope. However, if the gelatinous material is removed by filtering device, life of filter element is extremely shortened and exchange frequency of the filter element becomes considerably higher. It affects continuous production of the film. If the dope is reapplied the dissolution process, productivity of the dope decreases seriously. In addition, in the dissolution process, usually the materials are heated and/or cooled. The change of the temperature of the materials possibly adversely affects properties of the materials. In the present invention, the gelatinous material is irreversible material such as the solute solidified to a jelly.

If the solution casting is performed with the dope including the gelatinous material, it is possible that the quality of the produced film is deteriorated by the gelatinous material in the film. Usually, a heat exchanger with use of heating medium is used for controlling the temperature of the dope in dope preparing process, transferring process and preservation process. However, if the efficiency of the heat exchange is insufficient, the temperature of the dope cannot be appropriately controlled, that possibly leads occurrence of foreign matter called skinning on low temperature portion of the heat exchanger.

An object of the present invention is to provide an apparatus for producing dope preferably used for solution casting method, in which gelatinous material and foreign matters are hardly occurred.

### DISCLOSURE OF INVENTION

In order to achieve the object and the other object, an apparatus for producing dope has a heat transfer device for transferring heat to a dope including polymer and solvent so as to control a temperature of the dope. The heat transfer device has a cylinder whose size is defined by JIS standard, which controls a temperature of the dope passing through inside the cylinder, and flanges attached to both ends of the cylinder, whose size is larger than a size defined by JIS standard corresponding to the size of the cylinder.

It is preferable that the heat transfer device has a pressurizer for pressurizing inside of the cylinder 0.05 MPa or more from atmospheric pressure. Further, it is preferable that an outer peripheral surface of the cylinder is surrounded by a jacket to form a passage in which heating medium flows for controlling the temperature of the cylinder, and each end of the passage is positioned within 5 cm from an opposite surface of the each flange to a surface on which the cylinder is attached. The heat transfer device may include a vacuum insulation member provided on the outer peripheral surface of the cylinder. In addition, it is preferable that roughness average (Ra) of the inner surface of the cylinder is in a range of 0.1 μm to 50 μm.

As another embodiment, there is a heat transfer device having a container for containing the dope. The container controls the temperature of the dope therein, and a pressurizer for pressurizing inside of the container 0.05 MPa or more from atmospheric pressure. The heat transfer device may include a vacuum insulation member provided on an outer surface of the container. In addition, it is preferable that roughness average (Ra) of the inner surface of the container is in a range of 0.1 μm to 50 μm.

According to the apparatus for producing dope of the present invention, since the flanges, which is attached to both ends of the cylinder and is heated, has the size larger than the size defined by JIS standard corresponding to the size of the cylinder, temperature profile along the cylinder becomes small. Therefore, the occurrence of the gelatinous material or so on in the dope is prevented.

### BRIEF DESCRIPTION OF DRAWINGS

FIG. 1 is a process drawing showing a series of processes of a solution casting method of the present invention;

FIG. 2 is a schematic diagram of a dope preparing device used in dope preparing process;

FIG. 3 is a schematic cross-sectional view of a transferring device used in transferring process;

FIG. 4 is an explanatory drawing of heat transfer among a dope, a cylinder and a heating medium;

FIG. 5 is a schematic cross-sectional view of a transferring device of another embodiment;

FIG. 6 is a schematic cross-sectional view of a transferring device of another embodiment;

FIG. 7 is a schematic cross-sectional view of a preservation device used in preservation process;

FIG. 8 is a schematic cross-sectional view of a transferring device of another embodiment;

FIG. 9 is a graph showing a relation between an association amount and a temperature in the dope;

FIG. 10 is a schematic diagram of a film production line used for the solution casting method;

FIG. 11 is a partial sectional view of a film production line of another embodiment used for a co-casting method;

FIG. 12 is a partial sectional view of a film production line of another embodiment used for the co-casting method; and

FIG. 13 is a partial sectional view of a film production line of another embodiment used for the co-casting method.

### BEST MODE FOR CARRYING OUT THE INVENTION

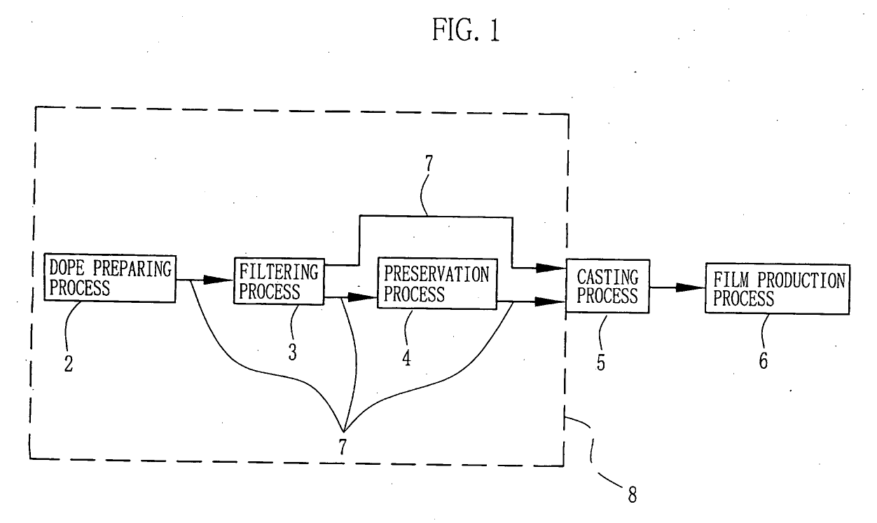

A solution casting method comprises a dope producing process 8, a casting process 5 and a film production process 6 (see FIG. 1). The dope producing process 8 include a dope preparing process 2, a filtering process 3, a preservation process 4, and transferring processes 7 for transferring dope among respective processes 2-5 (shown as allows in FIG. 1). For the transferring process 7, a transferring device (transferring pipe), which is described later in detail, is used. An apparatus for producing dope of the present invention (used for the dope producing process 8) includes heat transfer devices used in a dope preparing device (used for the dope preparing process 2), a preservation device (used for the preservation process 4), and a transferring device (used for the transferring process 7). Note that the process of solution casting is not limited to that in FIG. 1. For example, it is possible to transfer the dope to the casting process 5 from the filtering process 3 without preserving the dope.

[Polymer]

A variety of polymers used in the present invention is not limited. For example, polyamides, polyolefins, norbornenes, polystyrenes, polycarbonates, polysulfones, polyacrylic acids, polymethacrylic acids, polyetheretherketones (PEEK) polyvinyl alcohols, polyvinyl acetates, cellulose derivatives (such as lower fatty acid ester of cellulose, cellulose acylate or the like) can be used.

In the present invention, it is preferable that a produced film has small optical anisotropy. For this purpose, the polymer used for producing the film in the present invention is the cellulose derivative, preferably the cellulose acylate, more preferably cellulose acetate, particularly cellulose triacetate (TAC), especially the TAC having acetylic degree between 59.5% and 62.5%.

The cellulose is constructed of glucose units having a hydroxyl group at second, third and sixth positions of carbon (see Chemical Formula 1). When the hydroxyl groups are acylated (—CO—R), the TAC is obtained. Properties, such as solubility, of the TAC can be controlled by changing substitution degree and position of the acylation. Especially, viscosity, isobaric specific heat or the like of the dope including the TAC can be controlled by changing substituents and the substitution degree of the hydroxyl group at sixth position, which is a side chain of cellobiose group.

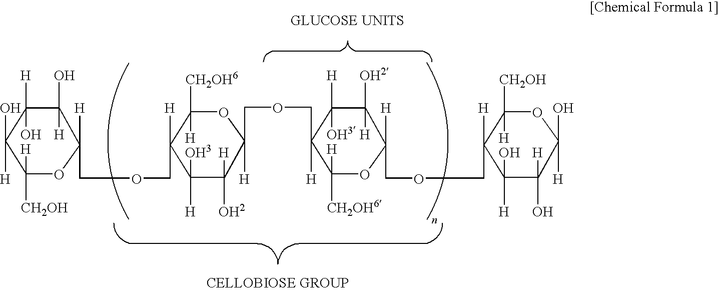

[Solvent]

As solvents, for example there are halogenated hydrocarbons (such as dichloromethane, chlorofolm and the like), esters (such as methyl formate, methyl acetate, ethyl acetate, amyl acetate, butyl acetate and the like), ethers (such as dioxane, dioxorane, tetrahydrofrane, diethylether, methyl-t-butylether and the like), aromatic hydrocarbons (such as benzene, toluene, xylene and the like), aliphatic hydrocarbons (such as hexane, heptane and the like), alcohols (such as methanol, ethanol, n-butanol and the like) and ketons (such as cyclopentanone, acetone, methylethyl ketone, cyclohexanone and the like). These solvents may be used separately or mixed.

In case the TAC is used, it is preferable that the mixture solvent whose main solvent is the methyl acetate (Tbp=56.3° C.) is used. The methyl acetate has superior environmental friendliness to that of the halogenated hydrocarbons such as the dichloromethane, and is easily disposed as waste solution generated in the solution casting. A relative proportion of the methyl acetate in the mixture solvent is preferably equal to or more than 50 wt. %, more preferably equal to or more than 60 wt. %. The solvents used as sub-solvents in the mixture solvent are preferable to have high affinity for the methyl acetate and boiling temperature in a range of 30° C. to 120° C., and to be easily handled. As these solvents, there are the cyclopentanone, the acetone, the methanol, the ethanol and the like.

[Additives]

To improve the properties of the film, additives may be added in the dope. As the additives, there are plasticizer (such as triphenylphosphate (TPP), biphenyldiphenyl phosphate, dipentaerythrithol hexaacetate and the like), UV-absorbing agent (such as oxybenzophenone type compounds, benzotriasol type compounds and the like), matting agents (such as particle of silicon dioxide and the like), thickening agent, oil gelling agent, retardation adjuster. However, the additives are not restricted in them. The additives may be added when the polymer is dissolved to the solvent, or added to the prepared dope in an inline method while solution casting. Further, the additives may be directly added in the dope, or a solution in which the additives are previously dissolved to the solvent may be added in the dope.

In the present invention, a dope temperature T (° C.) is kept in a predetermined range while the dope preparing process, the dope transferring process and the dope preservation process. For this purpose, the properties, especially the viscosity and the isobaric specific heat of the dope need to be adjusted appropriately. The conditions of the dope are described later in detail.

[Dope Preparing Process]

In case the dope is produced by cool-dissolving method, at first the TAC is swelled by the solvent to become swelling solution. A temperature of the swelling solution is preferable in a range of 10° C. to 60° C., particularly at room temperature so as to be easily handled. It is preferable that the polymer is stirred to swell evenly in the solvent. Every known method can be used to stir the polymer. Note that although the stirring period is not limited, it is preferable in a range of 5 to 120 minutes. If the period is less than 5 minutes, the polymer possibly does not swell evenly. If the period is more than 120 minutes, productivity of the film is decreased. To avoid these problems, the kind of the solvent (in using the single solvent), the combination and/or the relative proportion of the solvents (in using the mixture solvent) are appropriately selected. The additives can be added in the swelling solution. The additives may be directly added in the swelling solution, or the solution in which the additives are previously dissolved to the solvent may be added in the swelling solution.

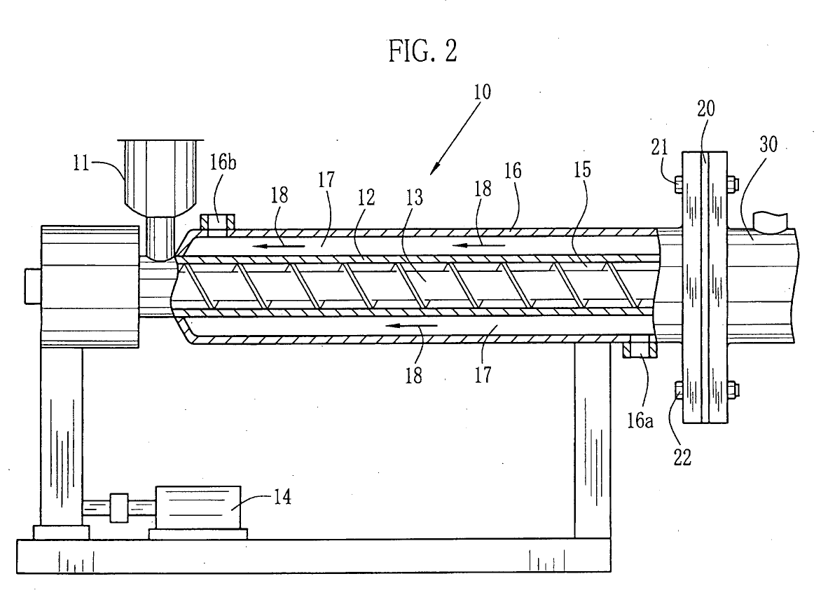

The swelling solution is supplied in a tank 11 of a dope preparing device 10, which is a component of the apparatus for producing dope, as shown in FIG. 2. In the dope preparing device 10, a screw 13 is provided inside a cylinder (pipe) 12. The screw 13 is rotated by a motor 14 through reduction gears (not shown). By the rotation of the screw 13, the swelling solution is mixed so that the dissolution thereof is accelerated, and the dope 15 is obtained. A jacket 16 is provided around the outer peripheral surface of the cylinder 12, and a heating medium passage 17 is formed within the jacket 16. The heating medium 18 is fed into the heating medium passage 17 to control temperature profile of the dope 15 within 5° C. Note that the heating medium 18 preferably flows from a downstream side orifice 16a to an upstream side orifice 16b (counter flow), however it can flow in the opposite direction (parallel flow). In addition, it is preferable that the inside of the cylinder 12 is pressurized 0.05 MPa or more from atmospheric pressure so as to prevent skinning occurred by foaming gasses dissolved in the swelling solution or the dope 15.

In the present invention, the method for preparing the dope 15 is not limited to the method described above. For example, heat-dissolving method can be applied, in which the polymer, the solvent and the specific additives is supplied in a mixing tank, and stirred by a stirrer, with keeping temperature thereof in a range of 40° C. to 130° C.

[Transferring Process]

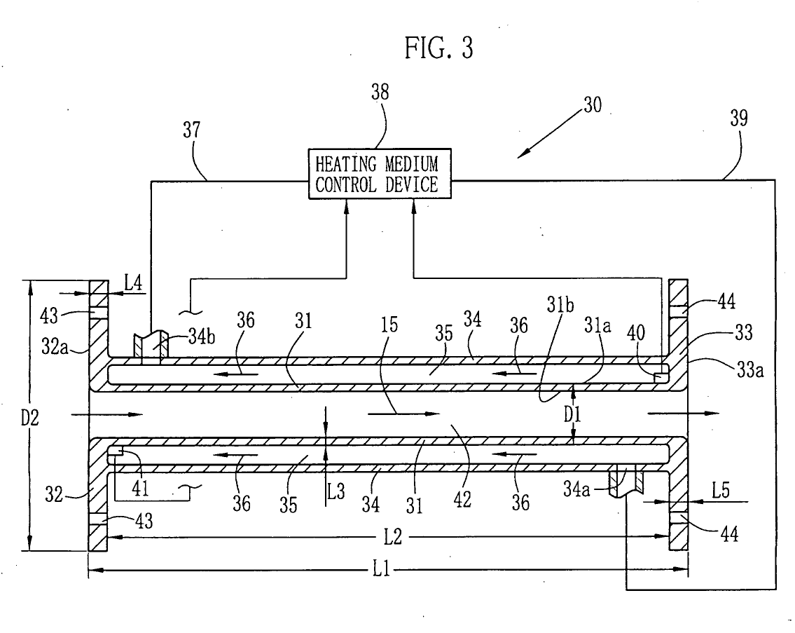

To a downstream side from the dope preparing device 10, a transferring device 30, which is also a component of the apparatus for producing dope, is attached through a gasket 20 with bolts 21, 22. The dope 15 is transferred by the transferring device 30 to a filtering device (not shown). As shown in FIG. 3, in the transferring device 30, flanges 32, 33 are attached to a cylinder (pipe) 31. In addition, a jacket 34 is provided around the outer peripheral surface of the cylinder 31, and a heating medium passage 35 (hereinafter called the passage) is formed between the jacket 34 and the outer peripheral surface of the cylinder 31. On the jacket 34, a downstream side orifice 34a and an upstream side orifice 34b is formed for supplying and discharging the heating medium 36. Note that the heating medium 36 preferably flows from the downstream side orifice 34a to the upstream side orifice 34b (counter flow), however it can flow in the opposite direction (parallel flow). The heating medium 36 flows to a heating medium control device 38 through a line 37, and the heating medium control device 38 controls the temperature and the like of the heating medium 36. After that, the heating medium 36 is fed into the passage 35 through a line 39. The circulation of the heating medium 36 as described above is preferable for reducing the cost. However, the flow method of the heating medium 36 is not limited to this example.

The outer peripheral surface 31a of the cylinder 31 contacts the heating medium 36, and an inner peripheral surface 31b of the cylinder 31 contacts the dope 15. To measure the temperature of the cylinder 31, it is preferable that thermometers 40, 41 are respectively provided in a downstream side and an upstream side of the outer peripheral surface 31a. A length of a passage 42 for the dope 15 (hereinafter called the dope passage) in the transferring device 30 is L1 (m) in the direction in which the dope 15 flows (hereinafter called the longitudinal direction). Note that the dope passage 42 is from an upstream side surface 32a of the flange 32 to a downstream side surface 33a of the flange 33 as shown in FIG. 3. A length of the passage 35 is L2 (m). In the flanges 32 and 33, boltholes 43 and 44 are respectively formed for engaging the flanges 32 and 33 and other equipments through the bolts (see FIG. 1).

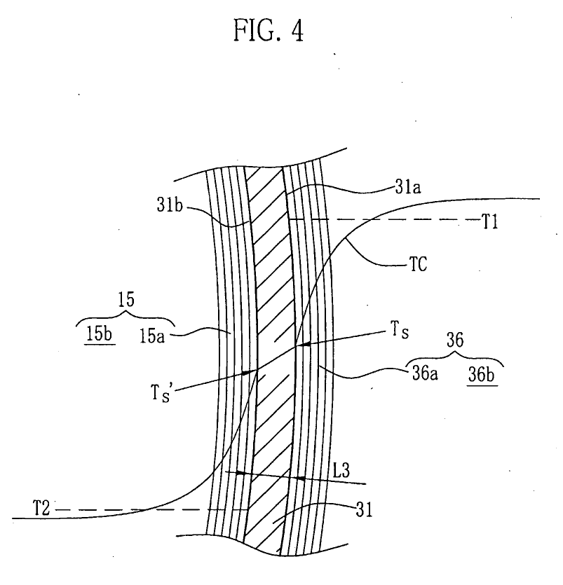

With reference FIG. 4, heat convection between the dope 15 and the cylinder 31, and between the cylinder 31 and the heating medium 36 are respectively explained in an experiment that the temperature of the dope 15 is lower than that of the heating medium 36. In addition, coefficient of heat transfer Hd, Hm, overall coefficient of heat transfer U, viscosity Vd, Vm of the dope 15 and the heating medium 36, isobaric specific heat Cd, Cm of the dope 15 and the heating medium 36, and retaining time Td, Tm of the dope 15 and the heating medium 36 are also explained.

A heat exchange between the heating medium 36 and the dope 15 is performed through a laminar film. In the heating medium 36, a liquid laminar film (hereinafter called heating medium laminar film) 36a which is in a laminar flow state is formed near the outer peripheral surface 31a of the cylinder 31. The heat transmission in the heating medium laminar film 36a is performed mainly by the heat conduction. A mainstream heating medium 36b, which is outside the heating medium laminar film 36a, flows ordinarily in a state of turbulent flow, and the heat convection between the mainstream heating medium 36b and the outer peripheral surface 31a of the cylinder 31 is performed by convection. An average temperature of the mainstream heating medium 36b is T1 (° C.), and a temperature of the outer peripheral surface 31a of the cylinder 31 is Ts (° C.).

In the dope 15, a liquid laminar film (hereinafter called dope laminar film) 15a which is in a laminar flow state is formed near the inner peripheral surface 31b of the cylinder 31. A mainstream dope 15b, which is inside the dope laminar film 15a, flows in a state of turbulent flow. The heat transmission between the mainstream dope 15b and the inner peripheral surface 31b of the cylinder 31 is performed by the heat convection. An average temperature of the mainstream dope 15b is T2 (° C.), and a temperature of the inner peripheral surface 31b of the cylinder 31 is Ts′ (° C.). The heat transmission between the outer peripheral surface 31a and the inner peripheral surface 31b is performed by the heat conduction. A temperature curve TC roughly shows a temperature gradient of the heating medium 36, the cylinder 31 and the dope 15. In the curve TC, temperature is shown along the vertical direction of the figure (the temperature is higher in upper portion of the figure), and position is shown along the horizontal direction of the figure.

When an area of the outer peripheral surface of the cylinder is A1(m²), and a coefficient of heat transfer between the heating medium 36 and the cylinder 31 (hereinafter called the coefficient of heating medium side heat transfer) is Hm (W/(m²·K)), a rate of heat transfer q1 (W) between the mainstream heating medium 36b and the outer peripheral surface 31a of the cylinder 31 is calculated from a formula (1):

q1=Hm·A1·(T1−Ts) Formula (1)

When an area of the inner peripheral surface of the cylinder is A2(m²) and a coefficient of heat transfer between the cylinder 31 and the dope 15 (hereinafter called the coefficient of dope side heat transfer) is Hd(W/(m²·K)), a rate of heat transfer q2 (W) between the inner peripheral surface 31b of the cylinder 31 and the mainstream dope 15b is calculated from a formula (2):

q1=Hd·A2·(Ts′−T2) Formula (2)

When a coefficient of heat conduction of the cylinder 31 is Ks(W/(m·K)), a logarithmic mean area of the cylinder 31 is A₁ₘ(m²), a thickness of the cylinder is L3(m), a rate of heat transfer q3 (W) through the cylinder 31 is calculated from a formula (3):

q3=Ks·A₁ₘ·(Ts−Ts′)/L3 Formula (3)

Note that the coefficient of heat conduction of the cylinder Ks used in the figure is based on the temperature of the inner peripheral surface 31b of the cylinder 31.

When the heating medium 36 controls the temperature of the dope 15, the rates of heat transfer q1, q2 and q3 are equal (q1=q2=q3). Accordingly, a formula (4) is obtained by transforming the formulas (1) to (3):

q=(T1−T2)/{(1/Hm·A1)+(L3/Ks·A₁ₘ)+(1/Hd·A2)} Formula (4)

A rate of heat transfer q4 of overall heat transmission in the transferring device 30, which is a double tube type of heat exchanger, is shown as a formula (5):

q4=U·A2·(T1−T2) Formula (5)

Note that U is an overall coefficient of heat transfer (W/(m²·K)), which is based on the area of the inner peripheral surface of the cylinder A2(m²). In addition, the rate of heat transfer q4 of overall heat transmission is equal to the rate of heat transfer q1, q2 and q3 (q1=q2=q3=q4). Accordingly, a formula (6) is obtained by transforming the formulae (4) and (5):

1/(U·A2)=(1/Hm·A1)+(L3/Ks·A₁ₘ)+(1/Hd·A2) Formula (6)

When the coefficient of heat conduction of the cylinder Ks is sufficiently large in the figure (6), L3/(Ks·A₁ₘ)≈0, and when the thickness of the cylinder L3 is sufficiently thin, A1 (the area of the outer peripheral surface of the cylinder)≈A2 (the area of the inner peripheral surface of the cylinder). By modifying the formula (6) according to these conditions, a formula (7) is obtained:

1/U=(1/Hm)+(1/Hd) Formula (7)

In addition, the formula (7) can be rewritten as a formula (8) under following expressions:

R=(1/U): overall heat transfer resistance

Rm=(1/Hm): heat transfer resistance of heating medium side

Rd=(1/Hd): heat transfer resistance of dope side

R=Rm+Rd Formula (8)

The formulae (7) and (8) shows that there is a need to reduce Rm and/or Rd (enlarge the coefficient of dope side and heating medium side heat transfer Hd and Hm) so as to reduce the overall heat transfer resistance R (enlarge the overall coefficient of heat transfer U). In considering this fact, the apparatus for producing dope of the present invention (including the dope preparing device, the transferring device, the preservation device and the like) satisfies following condition:

a) overall coefficient of heat transfer U>10(W·m⁻²·K⁻¹)

Accordingly, since the heat transfer resistance becomes small, the temperature control of the cylinder 31 can be easily performed. This means that the temperature of the dope 15 can be easily controlled (especially promoted heat retention).

To transfer heat energy from the heating medium 36 to the dope 15 efficiently, the coefficient of heating medium side heat transfer Hm (W·m⁻²·K⁻¹) is made larger than the coefficient of dope side heat transfer Hd (W·m⁻²·K⁻¹):

b) coefficient of heating medium side heat transfer Hm> coefficient of dope side heat transfer Hd

In addition, a ratio of the coefficient of heating medium side heat transfer Hm to the coefficient of dope side heat transfer Hd is preferable in a range c):

c) 2<(Hm/Hd)<1000

If the ratio of the coefficient of heating medium side heat transfer Hm to the coefficient of dope side heat transfer Hd (Hm/Hd) is less than or equal to 2, there is possibility that the heat energy is not sufficiently supplied to the cylinder 31, which causes that the dope 15 is not sufficiently heated. If Hm/Hd is greater than or equal to 1000, the overall coefficient of heat transfer U is determined by only the coefficient of heating medium side heat transfer Hm. Under this condition, since the heat transfer from the cylinder 31 to the dope 15 is very little, it possibly becomes difficult to keep the dope average temperature T2 (° C.) constant. The coefficient of heat transfer Hm, Hd is determined based on the approximation of Pohlhausen.

In the present invention, it is preferable to use liquids as the heating medium 36. For example, if the water flows in the passage 35, the coefficient of heating medium side heat transfer Hm is ordinary in a range between 250 W/(m²·K) and 5000 W/(m²·K). However, if the air is used as the heating medium 36, Hm is in a range between 10 W/(m²·K) and 250 W/(m²·K). In this condition, it possibly becomes difficult to keep the dope average temperature T2 (° C.) constant. In considering this problem, in the present invention, the hot water, oil, brine (registered brand) or the like is used as the heating medium 36.

The viscosity of each of the dope 15 and the heating medium 36 affects the heat convection. When the viscosity is too high, it is hard to occur the heat transfer, and the coefficient of heat transfer Hd, Hm becomes small. In addition, if a difference between the viscosity Vd of the dope and the viscosity Vm of the heating medium is large, a difference between the each coefficient of heat transfer Hd, Hm becomes also large. In this condition, it possibly becomes that the preferable ratio of the coefficient of heat transfer (2<(Hm/Hd)<1000) is hard to be kept. In considering this problem, it is preferable that a ratio of the viscosity Vd (Pa·s) of the dope at the dope average temperature T2 (° C.) to the viscosity Vm (Pa·s) of the heating medium at the heating medium average temperature T1 (° C.) is in a range d):

d) 10<(Vd/Vm)<10⁶

When the ratio (Vd/Vm) is less than or equal to 10, it possibly becomes difficult to stably feed the heat energy to the dope 15. When the ratio (Vd/Vm) is greater than or equal to 10⁶, it possibly becomes that the heat energy of the heating medium 36 hardly transmits to the dope 15. Note that it is preferable that both of the dope average temperature T2 (° C.) and the heating medium average temperature T1 (° C.) are in a range 0° C. to 100° C.

It is preferable that the dope viscosity Vd (Pa·s) and velocity of the dope (m/s) are controlled so that a pressure loss, which occurs when the dope 15 passes through the dope passage 42, is less than or equal to 1×10⁵ Pa (≈1 kgf/cm²). When the pressure loss becomes considerably high, there becomes a need to form the cylinder 31 from durable materials, which costs a lot. In addition, if the thickness of the cylinder L3 is increased for improving the pressure resistance, it becomes difficult to control the heat conduction from the outer peripheral surface to the inner peripheral surface of the cylinder in the overall heat transmission, and to control the each coefficient of heat transfer Hd, Hm.

It is preferable that a ratio of an isobaric specific heat of the dope Cd (J·K⁻¹·g⁻¹) to an isobaric specific heat of the heating medium Cm (J·K⁻¹·g⁻¹) is in a range e):

e)0.1<(Cd/Cm)<2

When the ratio (Cd/Cm) is greater than or equal to 2, since a large heat quantity is required for increasing the temperature of the dope 15, it is possible that the heat quantity of the heating medium 36 is insufficient to heat the dope 15 to the dope average temperature T2 (° C.). When the ratio (Cd/Cm) is less than or equal to 0.1, since the isobaric specific heat of the heating medium 36 becomes too high, the heat quantity of the heating medium 36 is excess to heat the dope 15 to the dope average temperature T2 (° C.). That increases the cost for heating the dope.

It is preferable that a ratio of an average time for the heating medium passing through the passage (hereinafter called the heating medium retaining time) Tm (s) to a retaining time of the dope 15 in the transferring device 30 (hereinafter called the dope retaining time) Td (s) is in a range f):

f) 1<(Tm/Td)<100

When the ratio (Tm/Td) is less than or equal to 1, it is possible that the heat from the heating medium 36 can not smoothly transfer to the dope 15, which leads that the dope 15 is not sufficiently heated. In addition, loss of heat energy becomes larger because of large amount of heat radiation from the retaining dope 15. Although the control of the heat transfer can be easier by fastening flow velocity of the heating medium 36, however, when the ratio (Tm/Td) is equal to or more than 100, there becomes a need to increase a pressure tightness of the heating medium passage 35, which causes increase of the manufacturing cost of the device.

As shown in FIG. 3, temperature data of the cylinder measured by the each thermometer 40, 41 are sent to the heating medium control device 38. The heating medium control device 38 controls the average temperature T1(° C.) and the velocity (m/s) of the heating medium 36 based on the temperature data. The positions on the cylinder where the temperatures are measured are not limited to the two positions which are respectively in downstream side and upstream side shown in the figure. In addition, a temperature sensor which can measure the temperatures of the positions along the longitudinal direction of the cylinder 31 may be attached to the cylinder 31, so that the temperature of the desired position can be measured and the heating medium control device 38 can control the average temperature T1(° C.) and the velocity (m/s) of the heating medium 36 based on the measured temperature. The smaller the temperature profile along the longitudinal direction of the transferring device 30 is, the more the heat conduction will be performed evenly, the dope components will be uniformed, and occurring of impurities caused by local heating will be prevented. However, it is difficult to realize the condition in which the temperature profile is very small, and implementation of this condition costs a lot. In considering of these problems, in the present invention, the temperature profile along the longitudinal direction of the transferring device 30 is preferably within 5° C. Note that the openings for supplying and discharging the heating medium 36 is not limited to the one pair as shown in FIG. 3. For example, a plurality of jackets may be attached to the cylinder 31 along the longitudinal direction thereof, and a pair of openings may be formed on each of the jackets so that the heating medium is supplied to the each jackets.

In case that the dope 15 includes one kind of organic solvent, it is preferable that the dope average temperature T2 (° C.) is in a range g-1) about a boiling point Tbp (° C.) of the solvent:

g-1) (Tbp-30)=T2(° C.)=Tbp; particularly

(Tbp-15)=T2(° C.)=Tbp

Since the dope 15 is kept its temperature at near boiling point Tbp (° C.), it is prevented that precipitation of solute such as the polymer caused by decreasing solubility of the solvent. Accordingly, occurrence of the skinning can be prevented. Further, since the dope temperature is high, an association amount in the dope is reduced and occurring of gelatinous material is prevented. In addition, since the dope temperature is less than or equal to the boiling point of the solvent, it is prevented that volatilization of large quantity of the solvent caused by boiling the solvent. Accordingly, it can be prevented that the precipitation of solute caused by the volatilization of the organic solvent.

As the solvent for dope preparing, the mixture solvent is often used for improving the solubility. For example, a solvent which is a mixture of the methyl acetate and plural kinds of alcohols may be used. In case that the mixture solvent does not have an azeotropic point, it is preferable that the dope average temperature T2(° C.) is in a range g-2) about a boiling point Tbpmin (° C.) of the solvent which has lowest boiling point in the mixture solvent:

g-2) (Tbpmin-30)≦T2(° C.)≦Tbpmin; particularly

(Tbpmin-15)≦T2(° C.)≦Tbpmin

In case that the mixture solvent is an azeotropic mixture, it is preferable that the dope average temperature T2(° C.) is in a range g-3) about an azeotropic point Tap (° C.) of the azeotropic mixture:

g-3) (Tap-30)≦T2(° C.)≦Tap; particularly

(Tap-15)≦T2(° C.)≦Tap

When the azeotropic point Tap (° C.) is higher than the boiling point Tbpmin (° C.), it is preferable that the dope average temperature T2 (° C.) is determined based on the boiling point Tbpmin (° C.), so that degeneration of the dope can hardly occur.

In the transferring device 30, the jacket 34 is extended to the each of flanges 32, 33. Accordingly, the length L2 of the heating medium passage 35 can be lengthen along the longitudinal direction of the cylinder 31 so as to prevent the occurrence of the temperature gradient in the cylinder 31. In addition, it is preferable that the cylinder 31, the jacket 34 and flanges 32, 33 are integrally connected to each other. According to this construction, the heat energy convectively transferred to the cylinder 31 can easily conductively transfer to the flanges 32, 33 so that the temperature of the flanges 32, 33 becomes nearly equal to the temperature of the cylinder 31. Since the dope average temperature T2(° C.) can be kept almost constant along the longitudinal direction of the transferring device 30, it can be prevented that the occurrence of the skinning on the flanges 32, 33 caused by the precipitation of solute. Note that in the present invention, the form of the jacket of the transferring device 30 shown in FIG. 3 is called full jacket.

In the present invention, it is preferable that the length L1 of the transferring device 30 is less than or equal to 15 meters. The heat energy is transferred to junctions of the flanges not mainly by the heat convection from the heating medium, but by the heat conduction from the cylinder 31. Therefore, it is highly possible that the temperature thereof cools down. To avoid this problem, it is preferable that the transferring device has long dope passage to reduce the number of the flanges. However, if the dope passage 42 is too long, it is possible that flexibility of piping arrangement is reduced or the installation place for the transferring device 30 is limited. In addition, about a length of each end of the transferring device 30 where the heating medium 36 is not supplied, it is preferable that each of the length L4 from the upstream side surface 32a of the flange 32 and the length L5 from the downstream side surface 33a of the flange 33 is less than or equal to 5 cm. In this condition, the occurrence of the skinning on the flanges 32, 33 can be prevented only by heat energy conductively transferred from the cylinder 31 to the flanges 32, 33.

In the transferring device 30, outside diameter D2 of the flanges 32, 33 is larger than a determined diameter of flange by JIS standard corresponding to the diameter D1 of the cylinder 31. For example, when a pipe defined by JIS 10K 25A is used as the cylinder 31, a flange defined by JIS 10K 40A may be used as the flange. In this structure, the bolts 21, 22 can be attached at positions further away from the cylinder 31 than when a flange having a diameter determined by JIS corresponding to the diameter of the cylinder 31 is used. Accordingly, the downstream side orifice 34a can be positioned nearer to the flange 33, and the upstream side orifice 34b can be positioned nearer to the flange 32, than the conventional structure. Since the heating medium passage 35 can be lengthen nearer to the flanges 32, 33 than the conventional structure, the temperature of whole of the transferring device 30 can be kept almost constant, which prevents the occurrence of the gelatinous material or so on from the dope. Note that the diameter of the flange 32 may be same or different to the diameter of the flange 33. In addition, it is preferable that the inside of the cylinder 31 is pressurized 0.05 MPa or more from atmospheric pressure so as to prevent the skinning occurred by foaming gasses dissolved in the dope 15.

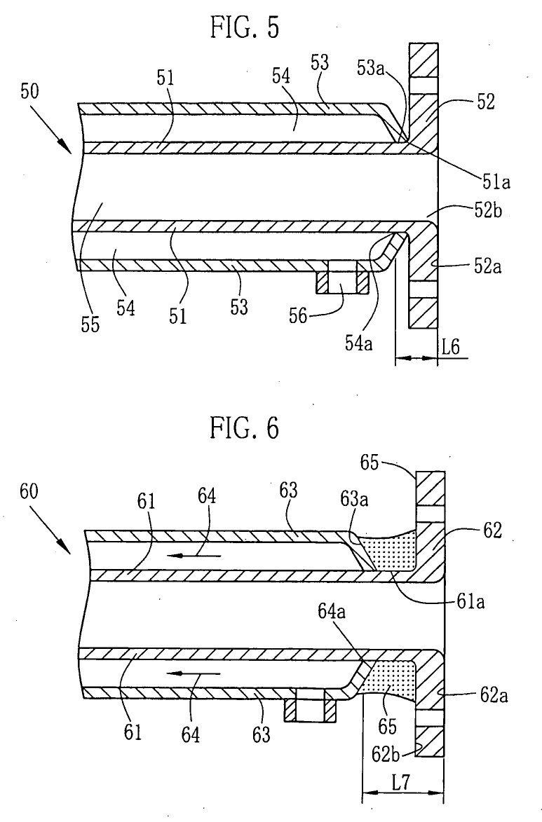

In a transferring device 50 part of which is shown in FIG. 5, a heating medium passage 54 is formed such that an end surface 53a of a jacket 53 is connected to a position 51a where a cylinder 51 and a flange 52 is connected. In this case, a distance L6 between a downstream side surface 52a of the flange 52 and an end 54a of the heating medium passage 54 is less than or equal to 5 cm. According to this construction, the flange 52 which is a part of a dope passage 55 can be heated. Therefore, the temperature profile can be reduced.

In a conventional transferring device 60 part of which is shown in FIG. 6, a flange 62 is attached to a cylinder 61, and a jacket 63 is also attached to the cylinder 61. A distance L7 between a downstream side surface 62a of the flange 62 and an end 64a of a passage in which a heating medium 64 flows is usually longer than 5 cm. In considering this problem, to minimize the temperature profile along the longitudinal direction of the transferring device 60, heat transfer cement 65 is coated on an outer surface 63a of the jacket 63, an exposed surface 61a of the cylinder 61 and an upstream side surface 62b of the flange 62. Heating energy convectively transferred from the heating medium 64 to the cylinder 61, is conductively transferred from the cylinder 61 to the flange 62 directly and through the heat transfer cement 65. Accordingly, the temperature of the flange 62 can be effectively controlled. Note that thermon cement, heat transfer cement T802 and heat transfer cement T-3 may be used as the heat transfer cement 65. However, the kind of the heat transfer cement 65 is not limited. In addition, an auxiliary heater such as a ribbon heater may be used instead of the heat transfer cement 65, or the heat transfer cement 65 and the auxiliary heater may be used together.

[Preservation Process]

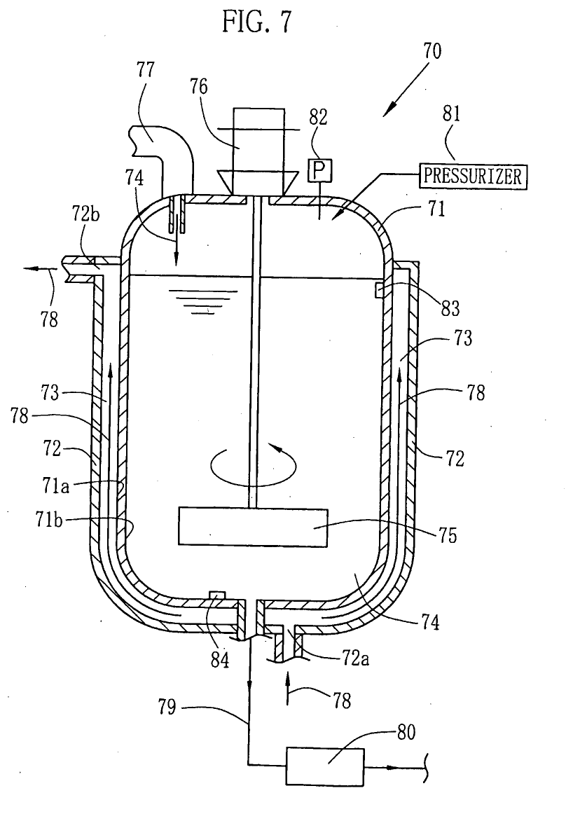

In a preservation device 70 of the present invention shown in FIG. 7, a jacket 72 is provided around a container 71, and a heating medium passage 73 is formed between the jacket 72 and the container 71. The preservation device 70 further includes a stirrer blade 75 to uniform a dope 74 contained in the container 71 and a motor 76 for rotating the stirrer blade 75. The dope 74 is poured into the container 71 from a pipe 77. It is preferable that a jacket (not shown) is attached to the pipe 77 so as to control the temperature of the pipe 77 and the dope 74. A heating medium 78 is fed to the heating medium passage 73 from an opening 72a of the jacket 72 by a feeding device (not shown), so as to convectively transfer the heat energy to an outer surface 71a of the container 71. It is preferable to use liquids as the heating medium 78 in terms of the heat conduction. In addition, it is preferable that the preservation of the dope 74 is performed according to the following conditions to keep the dope temperature constant:

a) overall coefficient of heat transfer U>10(W·m⁻²·K⁻¹)

b) coefficient of heating medium side heat transfer Hm> coefficient of dope side heat transfer Hd

c) 2<(Hm/Hd)<1000

d) 10<(Vd/Vm)<10⁶

e) 0.1<(Cd/Cm)<2

For example, when a stir tank of 200 L is used, it is preferable that a retaining time Tm (s) for the heating medium 78 being passed through the heating medium passage 73 is in a range of 10 s to 3600 s. If the retaining time Tm is longer than 3600 s, it is possible that the heat energy in the heating medium 78 is not sufficiently transferred to the outer surface 71a of the container 71, which causes difficulty in keeping the temperature of the outer surface 71a of the container 71 constant. In addition, to realize this condition, a heating medium control device (not shown) is required to become larger, which costs a lot. However, if the retaining time Tm is shorter than 10 s, the jacket 72 is required to have high-pressure capacity because large friction force will be generated in the jacket.

The heat energy in the heating medium 78 is transferred to the outer surface 71a of the container 71. Then the heat energy is transferred to an inner surface 71b of the container 71. Finally the heat energy is transferred to the dope 74 to control the temperature of the dope 74. After that, the heating medium 78 is discharged from an opening 72b of the jacket 72. It is preferable that the heating medium 78 is circulated with its temperature and feed rate being controlled by the heating medium control device (not shown), in terms of cost.

The dope 74 is preserved in the preservation device 70 with its temperature being kept constant. In the casting process (see FIG. 1), a feed rate of the dope 74 is controlled according to an opening rate of a jacketed valve 80 connected to the container through a pipe 79. It is preferable that a jacket is attached to the pipe 79 so as to control the temperature of the dope 74 which flows. In addition, it is preferable that jacketed valves are used as valves used in the each process shown in FIG. 1. The valve has a plurality of components, therefore it become possible that the non-jacketed valve has a low temperature portion. In the low temperature portion, it is possible that the skinning is occurred by the precipitation of the polymer or the like from the dope.

It is preferable that pressure in the container 71 is monitored by a pressure gauge 82 and pressurized 0.05 MPa or more from the atmospheric pressure by a pressurizer 81, so as to prevent the skinning occurred by foaming gasses dissolved in the dope 74.

To keep the temperature of the dope 74 almost constant, it is preferable that the temperature of the dope 74 is monitored by a thermometer 83 provided on an upper portion of the container 71 and a thermometer 84 provided on a lower portion of the container 71, as shown in FIG. 7. It is preferable that a difference of the measured temperature between the thermometers 83 and 84 is less than 5° C. In addition, it is preferable that the preservation of the dope is performed according to one of the following conditions g-1) to g-3) as same as the transfer of the dope, according to the kind of the solvent in the dope:

g-1) (Tbp-30)≦T2(° C.)≦Tbp; particularly

(Tbp-15)≦T2(° C.)≦Tbp

g-2) (Tbpmin-30)≦T2(° C.)≦Tbpmin; particularly

(Tbpmin-15)≦T2(° C.)≦Tbpmin

g-3) (Tap-30)≦T2(° C.)≦Tap; particularly

(Tap-15)≦T2(° C.)≦Tap

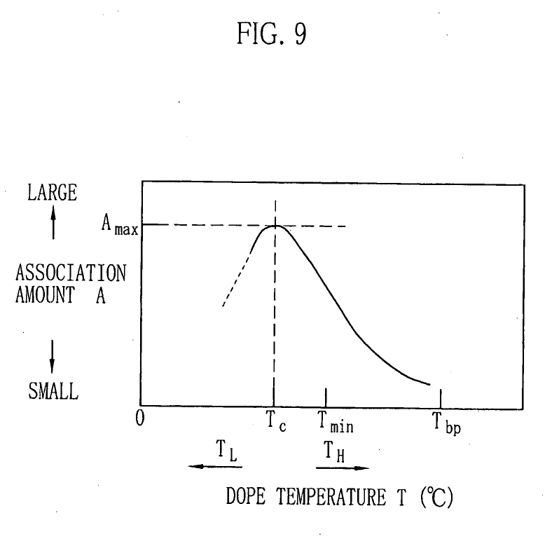

In this condition, the dope preparing can be performed without the dope temperature reaching at a maximum temperature Tc (° C.) shown in FIG. 9, at which the association amount in the dope is maximized, three times or more.

The control of the dope temperature is performed preferably from after the filtering process 3 to before the casting process 5, particularly from after the dope preparing process 2 to before the casting process 5, especially from the dope preparing process 2 to before the casting process 5 (see FIG. 1). In particular, in the transferring process 7, it is preferable to control the dope temperature as far as possible. However, there is a case that it is difficult to provide the device with use of the heating medium because of limited space for installing the device and so on. In this case, another example of the transferring device, which will be explained below, can be used.

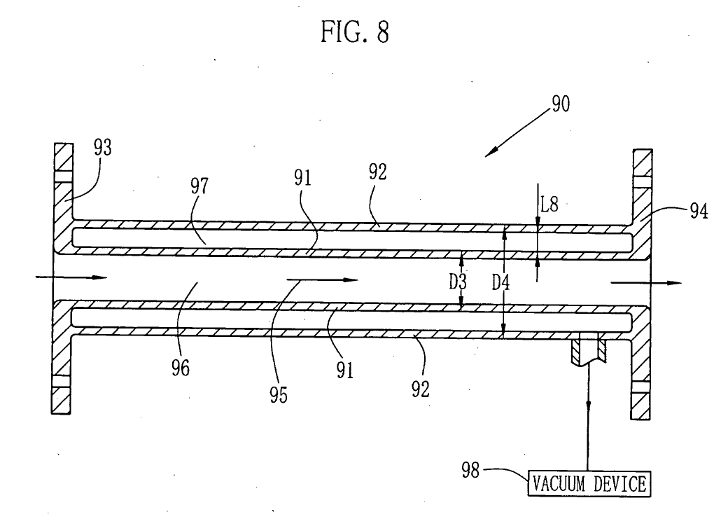

A transferring pipe 90 as the transferring device is shown in FIG. 8. The transferring pipe 90 includes an inner pipe 91 and an outer pipe 92 in which the inner pipe 91 is inserted. In addition, flanges 93, 94 are respectively attached to both ends of the pipes 91, 92. Inside of the inner pipe 91 is a passage 96 for the dope 96. A space between the outer pipe 92 and the inner pipe 91 becomes a vacuum insulation layer 97 by a vacuum device 98 attached to the outer pipe 92. In the present invention, stainless, glass or the like is preferably used as the material of the inner pipe 91. An outer diameter D3 of the inner pipe 91 is preferable in a range of 0.01 m to 1 m. In addition, stainless, glass or the like is also preferably used as the material of the outer pipe 92, and an outer diameter D4 of the outer pipe 92 is preferable in a range of 0.02 m to 1.5 m. Under this condition, a thickness L8 of the vacuum insulation layer 97 is in a range of 0.005 m to 0.745 m, and the vacuum device 98 controls the vacuum in the vacuum insulation layer 97 less than or equal to 10 Pa. To prevent heat transferred by radiation from the dope 95 from being emitted from the transferring pipe 90, it is preferable that plating treatment is applied to an outer peripheral surface of the inner pipe 91 and an inner peripheral surface of the outer pipe 92. Chrome, zinc alloy, brass chrome or the like is preferably used as a plating material, and any known methods, such as electrolytic method and electroless method can be used for the plating process.

By forming the vacuum insulation layer around the respective jackets of the dope preparing device 10, the transferring device 30, 50, 60 and the preservation device 70, it is prevented that the heat energy in the heating medium is released from the jacket. Further, the vacuum insulation layer can be provided instead of the jackets in the devices 10, 30, 50, 60, 70.

It is preferable that roughness average (Ra) of the inner surface of each of the cylinders 12, 31, 51, 61 and the container 71, which contacts to the dope, is in a range of 0.1 μm to 50 μm. When the roughness average is greater than or equal to 0.1 μm, the heat convection is made efficient because a heat convection area, between the dope and the inner surface of the cylinder or the container, is large. However, if the roughness average is more than 50 μm, it is possible that gas babbles exist in concaves, and that causes the skinning.

In the solution casting method shown in FIG. 1, between the dope preparing process 2 and immediately before the casting process 5, it is preferable that the dope temperature does not reach at the maximum temperature Tc (° C.) three times or more. More preferably, the dope temperature is kept in a high temperature range TH (° C.) with the dope temperature never reaching at the maximum temperature Tc (° C.) in between the dope preparing process 2 and immediately before the casting process 5. The maximum temperature Tc (° C.) is determined according to the kind of the dope. For example, when the polymer is TAC (substitution degree of acetylation is 2.8) and the solvent is methyl acetate, the maximum temperature Tc is 35° C.

### [Film Production Method]

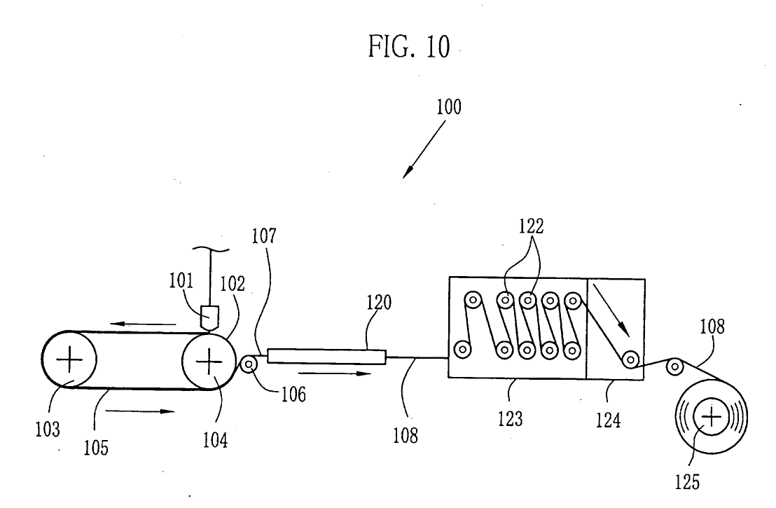

A method for producing a film from the dope produced by the apparatus for producing dope (the dope preparing device, the transferring device, the preservation device) will be explained. In a film production line 100, a casting die 101 is positioned above a casting belt 102. The casting belt 102 continuously moves in accordance with the rotation of rollers 103, 104 driven by a driver (not shown). The dope is cast on the casting belt 102 from the casting die 101. A width of the cast dope is preferably greater than or equal to 2000 mm, more preferably greater than or equal to 1400 mm. The dope becomes a casting film 105 on the casting belt 102, and after the casting film 105 has had self-supporting properties, it is peeled from the casting belt 102 as a soft film 107 with support of a peeling roller 106. Note that although the belt is used as the support as shown in FIG. 10, a rotary drum or the like may be used as the support.

The soft film 107 becomes a film 108 by being dried in a tenter type drying device 120. The film 108 is transported to a drying chamber 123 in which many rollers 122 are provided, and the film 108 after the drying is cooled in a cooling chamber 124. Note that the cooling temperature in the cooling chamber 124 is not restricted especially. However, the cooling temperature is preferably the room temperature so as to prevent the film-to-film adhesion when the film 108 is wound by a winding device 125. Side edge portions of the film 108 transported from the cooling chamber 124 may be cut off, and the knurling may be made.

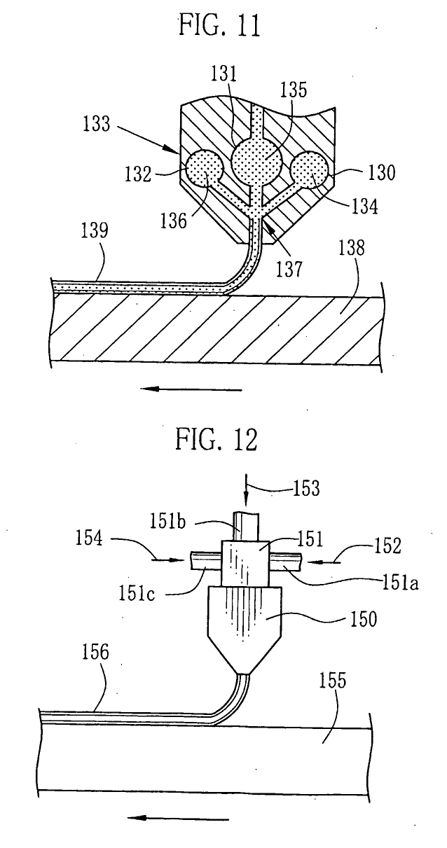

The film production method (the solution casting method) described above is the casting method for forming a single layer with use of the casting die 56 for casting the one dope. However, the solution casting method with use of the dope of the present invention is not restricted in the above example, for example, may be casting methods for forming plural layers. The examples of them will be explained in the following with reference to figures. Note that in FIG. 11 to FIG. 13, the explanations and the illustration of the same members will be omitted as the film production line 100 in FIG. 10.

As shown in FIG. 11, the casting die 133 is a multi-manifold type having plural manifolds 130, 131, 132, into which dopes 134, 135, 136 are respectively supplied. Note that the pipes for feeding the dopes are not illustrated. Thereafter, the dopes 134-136 are joined at a joining point 137, and cast on a casting belt 138 to form a casting film 139. Then the casting film 139 is peeled as the film. Note that it is preferable that at least one of the dopes 134, 135, 136 is produced by the apparatus for producing dope of the present invention when the multi-manifold type of casting die 133 is used for the casting. Especially, it is most preferable that all of the dopes 134, 135, 136 are produced by the apparatus for producing dope of the present invention.

The other example of the co-casting method will be explained with reference to FIG. 12. A feed block 151 is attached to an upstream side of a casting die 150. The feed block 151 is connected through pipes 151a-151c to a dope feeding device (not shown), and dopes 152-154 are fed from the dope feeding device to the feed block 151 and joined therein. Thereafter, the dopes 152-154 are cast on a casting belt 155 with use of the casting die 150 to form a casting film 156. The casting film 156 is peeled and dried to become a film, after having had self-supporting properties. Note that it is preferable that at least one of the dopes 152-154 is produced by the apparatus for producing dope of the present invention when the feed block 151 attached to the casting die 150 is used for the casting. Especially, it is most preferable that all of the dopes 152-154 are produced by the apparatus for producing dope of the present invention. Note that a rotary drum may be used as the support instead of the belts in FIGS. 11&12.

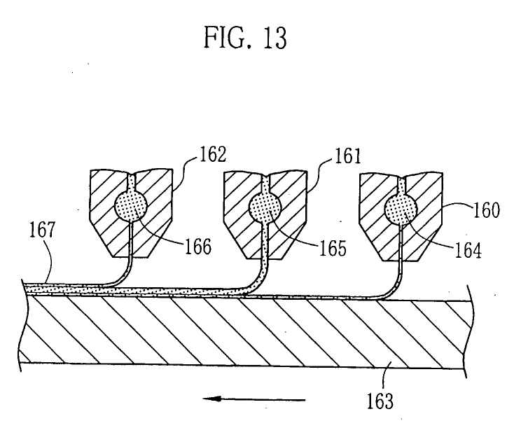

Then a sequentially casting method will be explained in reference to FIG. 13. Three dies 160-162 are disposed above a casting belt 163. Dopes 164-166 are respectively fed into casting dies 160-162, and cast on the belt 163 to form a casting film 167. Then the casting film 167 is peeled and dried to become a film. Note that it is preferable that at least one of the dopes 164-166 is produced by the apparatus for producing dope of the present invention when the sequentially casting method is used. Especially, it is most preferable that all of the dopes 164-166 are produced by the apparatus for producing dope of the present invention.

As another example than the above ones, for example, the dope produced by the present invention may be used in a hyper cooling casting method in which a rotary drum is cooled. Further, the dope produced by the present invention may be used in a combination of the co-casting method and sequentially casting method, for example, as at least one of the casting die in the sequential casting method illustrated in FIG. 13, the casting die of the multi-manifold type may be used. As another experiment, the feed block may be provided in the upstream side of at least one of the casting die in the sequential casting method illustrated in FIG. 13.

[Films]

The film obtained in one of the examples of the solution casting method is excellent in the optical properties, since the gelatinous material and the skinning are not occurred in the dope. The film can be used as the protective film. When the protective films are adhered to both surfaces of a polarized film including polarizers, a polarizing filter having the excellent optical properties is produced. Further, an optical compensation film having an optical compensation sheet on the film can be produced. These products (for example, the polarizing filter, the optical compensation film, an antireflection film in which antiglare layers are formed on the film and the like) can construct a liquid crystal display. Further, photosensitive layers are formed on the film to produce a photosensitive material.

Because the overall coefficient of heat transfer U is controlled to be greater than or equal to 10 (W·m⁻²·K⁻¹), the heat energy in the heating medium can be transferred to the dope at desired rate of heat transfer q(W). Note that the overall coefficient of heat transfer U can be appropriately controlled by selecting the type of the heat transfer device, the properties of the dope (such as the isobaric specific heat Cd, the viscosity Vd and the like), and the properties of the heating medium (such as the kind of the heating medium, the isobaric specific heat Cm, the viscosity Vm and the like).

### EXAMPLE 1

Examples with Experiments were performed, and the explanation thereof will be made. The explanations about Experiment 1 will be made in detail, and the same explanations will be omitted according to Experiments 2 and 6, and Experiments 7 and 15 as a comparison.

Dope A and dope B ware prepared from the following contents, and used in Experiment 1.

| | | |
|---|---|---|
| Cellulose triacetate | 28 | pts. mass. |
| (substitution degree of acetyl group was 2.83, | | |
| viscometric average degree of polymerization | | |
| was 320, moisture content was 0.4 mass. %, | | |
| viscosity of 6% by mass of dichloromethane | | |
| solution was 305 mPa · s.) | | |
| Methyl acetate (boiling point: 56.9° C.) | 70 | pts. mass. |
| Cyclopentanone (boiling point: 130° C.) | 5 | pts. mass. |
| Acetone (boiling point: 56.1° C. to 56.5° C.) | 5 | pts. mass. |
| Methanol (boiling point: 64.65° C.) | 5 | pts. mass. |
| Plasticizer A (dipentaerythritholhexaacetate) | 1 | pts. mass. |
| Plasticizer B (Triphenyl phosphate; TPP) | 1 | pts. mass. |
| Particles (silica, diameter of 20 nm) | 0.1 | pts. mass. |
| UV-absorbing agent a | 0.1 | pts. mass. |
| (2,4-bis-(n-octylthio)-6-(4-hydroxy-3,5-di- | | |
| tert-butylanylino)-1,3,5-triazine) | | |
| UV-absorbing agent b | 0.1 | pts. mass. |
| (2-(2′-hydroxy-3′,5′-di-tert-butylphenyl)-5- | | |
| chrolobenzotriazol) | | |
| UV-absorbing agent c | 0.1 | pts. mass. |
| (2-(2′-hydroxy-3′,5′-di-tert-amylphenyl)-5- | | |
| chrolobenzotriazol) | | |
| C₁₂H₂₅OCH₂CH₂O—P(═O)—(OK)₂ | 0.05 | pts. mass. |

The mixture solvent is sent to a mixing tank, and the TAC is sent to the mixing tank and stirred with the mixture solvent for 60 minutes by a stirrer blade to obtain a crude solution, while the temperature of the mixture is controlled in a range of 38° C. to 42° C. Then the additives are sent to the mixing tank and stirred with the crude solution for 30 minutes to obtain the dope A, while the temperature of the mixture is controlled in a range of 38° C. to 42° C. The dope A is confirmed with eyes that undissolved contents is not in the dope A. The acetone has the lowest boiling point Tbpmin (=56.1° C.) in the mixture solvent. Therefore, the range of the temperature (38° C. to 42° C.) of the dope A in the dope preparing process and the preservation process satisfies the relation:

(Tbpmin-30)=26.1(° C.)≦dope temperature≦56.1(° C.)=Tbpmin.

The dope A is transferred to a filtering device by the transferring device 30 while the dope temperature is heated. The cylinder 31 of the transferring device 30 is a pipe (JIS 10K 25A) whose length L1 is 1 meter. The roughness average (Ra) of the inner surface 31b of the cylinder 31 is 10 μm. The heating medium 36 is hot water, and flows in the heating medium passage 35 in counter flow to the dope 15 in conditions that the heating medium average temperature T1 is 41° C. and the flow velocity of the heating medium is 6.6×10⁻¹ m/s so that the dope average temperature T2 is 40° C. and the temperature profile along the longitudinal direction of the transferring device 30 is within 5° C. According to this condition, the heating medium retaining time Tm is 1.5 seconds. When the viscosity Vd (Pa·s) of the dope at the dope average temperature T2 (° C.) and the viscosity Vm (Pa·s) of the heating medium at the heating medium average temperature T1 (° C.) was measured by rheometer, the ratio Vd/Vm is 10⁵. The flow velocity of the dope 15 is set at 3.1×10⁻² m/s so that the dope retaining time Td is 30 seconds. Accordingly, the retaining time ratio Tm/Td is 0.05. When the isobaric specific heat Cd of the dope at the dope average temperature T2 (40° C.) and the isobaric specific heat Cm of the heating medium at the heating medium average temperature T1 (41° C.) are measured by Differential Scanning Calorimetry (DSC), the isobaric specific heat ratio Cd/Cm is 0.35. The transferred dope is confirmed with eyes that the gelatinous material and the skinning are not in there (∘). The overall coefficient of heat transfer U derived from the heat exchange experiment is 80(W·m⁻²·K⁻¹). The ratio of the heat convection Hm/Hd is 3.0.

In Experiment 2, the heat transfer cement (THERMON CEMENT) 65 is coated on the conventional type of transferring device, to form a transferring device 60. The dope A is transferred by the transferring device 60. The cylinder of the transferring device 60 is a pipe (JIS 10K 25A) whose length is 1 meter. The roughness average of the inner surface of the cylinder is 10 μm. The heating medium 64 is hot water, and flows in conditions that the heating medium average temperature T1 is 41° C. and the flow velocity of the heating medium is 6.6×10⁻¹ m/s so that the dope average temperature T2 is 40° C. and the temperature profile along the longitudinal direction of the transferring device 60 is within 5° C. According to this condition, the heating medium retaining time Tm is 1.5 seconds. When the viscosity Vd (Pa·s) of the dope at the dope average temperature T2 (° C.) and the viscosity Vm (Pa·s) of the heating medium at the heating medium average temperature T1 (° C.) was measured by rheometer, the ratio Vd/Vm is 10⁵. The flow velocity of the dope is set at 3.1×10⁻² m/s so that the dope retaining time Td is 30 seconds. Accordingly, the retaining time ratio Tm/Td is 0.05. When the isobaric specific heat Cd of the dope at the dope average temperature T2 (40° C.) and the isobaric specific heat Cm of the heating medium at the heating medium average temperature T1 (41° C.) are measured, the isobaric specific heat ratio Cd/Cm is 0.35. The transferred dope is confirmed with eyes that the gelatinous material and the skinning are not in there (∘). The overall coefficient of heat transfer U is 90(W·m⁻²·K⁻¹). The ratio of the heat convection Hm/Hd is 3.1.

In Experiment 3, the TAC is stirred with the mixture solvent for 60 minutes, while the temperature of the mixture is controlled in a range of 40±3° C. After the TAC is sufficiently swelled in the mixture solvent, the additives are sent to the mixture and stirred with the mixture for 60 minutes to obtain the swelling solution. At that time, the temperature of the mixture is also controlled in the range of 40±3° C. The swelling solution is sent to the tank 11 of the dope preparing device 10. Hydrofluorocarbon is used as the heating medium 18, which is sent to the heating medium passage 17 with its temperature being controlled at −70° C. The screw 13 rotates to shear the swelling solution so as to dissolve the TAC in the mixture solvent. According to these processes, the dope B is obtained.

The dope B is heated and transferred by the transferring device 30 as same as Experiment 1, so that the dope temperature becomes and is kept at 40° C. (=the dope average temperature T2). Therefore, the dope temperature in the transferring satisfies the relation (Tbpmin-30)≦dope temperature (° C.)≦Tbpmin. The heating medium average temperature T1 is 41° C., the flow velocity of the heating medium is 6.6×10¹ m/s, and the heating medium retaining time Tm is 1.5 seconds. When the viscosity Vd (Pa·s) of the dope at the dope average temperature T2 (° C.) and the viscosity Vm (Pa·s) of the heating medium at the heating medium average temperature T1 (° C.) was measured by rheometer, the ratio Vd/Vm is 10⁵. The dope retaining time Td is 30 seconds, and the retaining time ratio Tm/Td is 0.05. When the isobaric specific heat Cd of the dope at the dope average temperature T2 and the isobaric specific heat Cm of the heating medium at the heating medium average temperature T1 are measured, the isobaric specific heat ratio Cd/Cm is 0.35. The maximum temperature Tc (° C.) measured by DLS (dynamic light scattering) is 35° C. It shows that the dope temperature once reached at the maximum temperature Tc. However, the transferred dope is confirmed with eyes that the gelatinous material and the skinning are not in there (∘). The overall coefficient of heat transfer U is 80(W·m⁻²·K⁻¹). The ratio of the heat convection Hm/Hd is 3.0.

Experiment 4 is performed in the same conditions as Experiment 1. The dope A is filtered by the filtering device. As the filtering device, a quantitative filtering device is used. A secondary side initial pressure of the filtering device is 0.07 MPa. The filtering device has a filter paper whose surface area is 1 m². A roughness average of an inner surface of the filtering device is 10 μm. A jacket covers around an outer surface of the filtering device to form a heating medium passage.

The heating medium is hot water, and flows in the heating medium passage in counter flow to the dope in conditions that the heating medium average temperature T1 is 41° C. and the flow velocity of the heating medium is 6.6×10⁻¹ m/s so that the dope average temperature T2 is 40° C. and the temperature profile along the filtering device is within 5° C. According to this condition, the heating medium retaining time Tm is 1.5 seconds. When the viscosity Vd (Pa·s) of the dope at the dope average temperature T2 (° C.) and the viscosity Vm (Pa·s) of the heating medium at the heating medium average temperature T1 (° C.) was measured by rheometer, the ratio Vd/Vm is 10⁵. When the isobaric specific heat Cd of the dope at the dope average temperature T2 and the isobaric specific heat Cm of the heating medium at the heating medium average temperature T1 are measured by DSC, the isobaric specific heat ratio Cd/Cm is 0.35. The forming does not occur despite the filtering has been continuously performed 7 hours. In addition, the gelatinous material and the skinning are not in gas-liquid interface (∘). The filtration pressure is raised to 0.1 MPa after continuous filtering. The overall coefficient of heat transfer U derived from the heat exchange experiment is 90(W·m⁻²·K⁻¹). The ratio of the heat convection Hm/Hd is 2.8.

In Experiment 5, the preservation device 70 shown in FIG. 7 is used. The container 71 is made of SUS316 and has a volume of 0.4 m³. The jacket 72 is attached to the container 71 to form the heating medium passage 73. To uniform the dope 74 in the container 71, the stirrer blade 75 rotates at 30 rpm. The jacket (not shown) is attached to the pipe 77, which is used for sending the dope 74 to the container 71, to control the dope temperature (at approximately 40° C.). As the heating medium 78, hot water is used.

The dope 74 is preserved for 24 hours in the preservation device 70 with the dope temperature being kept at 41° C. The jacket (not shown) is attached to the pipe 79 to control the dope temperature at 41° C. The pressurizer 81 feeds N₂ gas to the container 71 so that the pressure in the container 71 is pressurized 0.18 MPa from the atmospheric pressure. Accordingly, the difference of the measured temperature between the thermometers 83 and 84 becomes less than 5° C. In this case, the dope retaining time Td is 24 hours (time for the preservation). When the viscosity Vd (Pa·s) of the dope 74 at the dope average temperature T2 (° C.) and the viscosity Vm (Pa·s) of the heating medium 78 at the heating medium average temperature T1 (° C.) was measured by the rheometer, the ratio Vd/Vm is 10⁵. When the isobaric specific heat Cd of the dope at the dope average temperature T2 (40° C.) and the isobaric specific heat Cm of the heating medium at the heating medium average temperature T1 (41° C.) are measured by DSC, the isobaric specific heat ratio Cd/Cm is 0.35. The dope 74 which was preserved for 24 hours is confirmed with eyes that the gelatinous material and the skinning are not in there (∘). The coefficient of heating medium side heat transfer Hm is 300 (W·m⁻²·K⁻¹), and the coefficient of dope side heat transfer Hd is 100 (W·m⁻²·K⁻¹). The ratio of the heat convection Hm/Hd is 3.

In Experiment 6, the dope A is transferred to the filtering device by the transferring device 30 while the dope temperature is kept constant. The cylinder 31 of the transferring device 30 is a pipe (JIS 10K 25A) whose length L1 is 1 meter. The roughness average (Ra) of the inner surface 31b of the cylinder 31 is 10 μm. The flanges 32, 33 have the diameter D2 defined by JIS 10K 40A. The heating medium 36 is hot water, and flows in the heating medium passage 35 in counter flow to the dope 15 in condition that the heating medium average temperature T1 is 41° C. so that the dope average temperature T2 is 40° C. and the temperature profile along the longitudinal direction of the transferring device 30 is within 5° C. When the viscosity Vd (Pa·s) of the dope at the dope average temperature T2 (° C.) and the viscosity Vm (Pa·s) of the heating medium at the heating medium average temperature T1 (° C.) was measured by the rheometer, the ratio Vd/Vm is 200. The retaining time ratio Tm/Td is 0.03. When the isobaric specific heat Cd of the dope at the dope average temperature T2 (40° C.) and the isobaric specific heat Cm of the heating medium at the heating medium average temperature T1 (41° C.) are measured by Differential Scanning Calorimetry (DSC), the isobaric specific heat ratio Cd/Cm is 0.35. The transferred dope is confirmed with eyes that the gelatinous material and the skinning are not in there (∘). The overall coefficient of heat transfer U derived from the heat exchange experiment is 100(W·m⁻²·K⁻¹). The ratio of the heat convection Hm/Hd is 3.0.

As the comparison, Experiment 7 is performed in the same conditions as Experiment 1, except a cylinder, which has an inner surface whose roughness average is 105 μm, is used. A small amount of the skinning of the gelatinous material is occurred (Δ).

As the comparison, Experiment 8 is performed in the same conditions as Experiment 2, except the heat transfer cement is not used. The temperature profile is 6° C., and a small amount of the gelatinous material is occurred (Δ).

As the comparison, Experiment 9 is performed in the same conditions as Experiment 1, except the dope is preserved at 25° C. A large amount of the gelatinous material is occurred (x).

In Experiment 10 as the comparison, the dope B is prepared in the same conditions as Experiment 3, and heated and transferred by the transferring device so that the dope temperature becomes and is kept at 40° C. While transferring the dope, the dope temperature dropped once down to 34° C., it means that the dope temperature reached to the maximum temperature Tc (35° C.) three times. A small amount of the gelatinous material is occurred in the transferred dope (Δ).

As the comparison, Experiment 11 is performed in the same conditions as Experiment 4, except the pressure of the secondary side of the filtering device is 0.04 MPa. The gelatinous material and the skinning, which are caused by the foaming, are occurred in the gas-liquid interface (x).

As the comparison, Experiment 12 is performed in the same conditions as Experiment 5, except the coefficient of dope side heat transfer Hd is 8 (W·m⁻²·K⁻¹) and the coefficient of heating medium side heat transfer Hm is 10 (W·m⁻²·K⁻¹). The gelatinous material is occurred (x).

As the comparison, Experiment 13 is performed in the same conditions as Experiment 5, except the coefficient of dope side heat transfer Hd is 8 (W·m⁻²·K⁻¹) and the coefficient of heating medium side heat transfer Hm is 9000 (W·m⁻²·K⁻¹). The gelatinous material is occurred (x).

As the comparison, Experiment 14 is performed in the same conditions as Experiment 6, except the viscosity ratio Vd/Vm is 10, the retaining time ratio Tm/Td is 0.03, and the isobaric specific heat ratio Cd/Cm is 0.01. It takes long time to heat the heating medium to a targeted temperature 40° C., and the gelatinous material is occurred (x).

As the comparison, Experiment 15 is performed in the same conditions as Experiment 6, except the viscosity ratio Vd/Vm is 10⁶, the retaining time ratio Tm/Td is 100, and the isobaric specific heat ratio Cd/Cm is 2. It takes long time to heat the heating medium to a targeted temperature 40° C., and the gelatinous material is occurred (x).

### EXAMPLE 2

In Example 2, the co-casting is performed with using the dope A or the dope B as a mainstream, which is prepared in one of Experiment 1 to Experiment 6, and dope C as sidestreams, which is prepared from the following contents. The dope C is prepared in the same conditions as the dope A.

| | | |
|---|---|---|
| Cellulose triacetate | 25 | pts. mass. |
| (substitution degree of acetyl group was 2.83, | | |
| viscometric average degree of polymerization | | |
| was 320, moisture content was 0.4 mass. %, | | |
| viscosity of 6% by mass of dichloromethane | | |
| solution was 305 mPa · s.) | | |
| Methyl acetate | 75 | pts. mass. |
| Cyclopentanone | 10 | pts. mass. |
| Acetone | 5 | pts. mass. |
| Methanol | 5 | pts. mass. |
| Ethanol | 5 | pts. mass. |
| Plasticizer A (dipentaerythritholhexaacetate) | 1 | pts. mass. |
| Plasticizer B (Triphenyl phosphate; TPP) | 1 | pts. mass. |
| Particles (silica, diameter of 20 nm) | 0.1 | pts. mass. |
| UV-absorbing agent a | 0.1 | pts. mass. |
| (2,4-bis-(n-octylthio)-6-(4-hydroxy-3,5-di- | | |
| tert-butylanylino)-1,3,5-triazine) | | |
| UV-absorbing agent b | 0.1 | pts. mass. |
| (2-(2′-hydroxy-3′,5′-di-tert-butylphenyl)-5- | | |
| chrolobenzotriazol) | | |
| UV-absorbing agent c | 0.1 | pts. mass. |
| (2-(2′-hydroxy-3′,5′-di-tert-amylphenyl)-5- | | |
| chrolobenzotriazol) | | |
| C₁₂H₂₅OCH₂CH₂O—P(═O)—(OK)₂ | 0.05 | pts. mass. |

The multi-manifold type casting die 133 shown in FIG. 11 is used for solution casting, instead of the casting die 101 shown in FIG. 10. The dope A transferred as Experiment 1 of Example 1 is sent to the manifold 135 to be cast as a base layer, and the dope C is sent to the manifolds 130, 132 to be cast as a surface layer and a lining layer. The dopes are cast from the multi-manifold type casting die 133, such that the width of the cast is 600 mm, a thickness of the dried surface layer is 3 μm, a thickness of the dried base layer is 74 μm, a thickness of the dried lining layer is 3 μm. The temperature of the casting belt 138 is 5° C., and a casting speed is 0.2 m/s. Following explanation is based on FIG. 10.

After the casting film has had self-supporting properties, it is peeled from the casting belt 102 as a soft film with support of the peeling roller 106. The soft film is dried for 20 minutes in the tenter type drying device 120 whose inlet and outlet temperature are 100° C. The obtained film is transported to and dried for 40 minutes in the drying chamber 123 whose temperature is kept in a range of 130° C. to 140° C. The film after the drying is transported to and cooled for 1 minute in the cooling chamber 124 whose temperature is kept at approximately 25° C. Then the film is wound by the winding device 125.

Experiment 2 to Experiment 6 of Example 2 are performed in the same conditions as Experiment 1, except the dope used in each corresponding experiments of Example 1 is used as the mainstream dope. The antireflection films are formed with use of the film obtained by Experiment 1 to Experiment 6, and evaluated.

(Preparation of Coating Solution A for Antiglare Layer)

In order to prepare a coating solution A for an antiglare layer, a mixture (DPHA, produced by NIPPON KAYAKU CO., LTD.) was used, in which dipentaerythritol pentaacrylate and dipentaerythritol hexaacrylate were mixed. The mixture of 125 g and bis(4-methacryloyl thiophenyl) sulfide (MPSMA, produced by SUMITOMO SEIKA CHEMICALS CO., LTD.) of 125 g were dissolved in a mixture solvent of 439 g that contained methylethylketone of 50 wt. % and cyclohexanone of 50 wt. %. Thus a first solution was obtained. Further, second solution was prepared. In the second solution, a photopolymerization initiator (IRGACURE 907, produced by Chiba Gaigy Japan Limited) of 5.0 g and photosensitizer (KAYACURE DETX, produced by NIPPON KAYAKU CO., LTD.) of 3.0 g were dissolved in methylethyl ketone of 49 g. The second solution was added to the first solution to obtain an added solution. The added solution was coating and thereafter cured with ultraviolet ray to obtain a coating layer, which had reflective index of 1.60. Further, crosslinked polystyrene particles (name of product: SX-200H, produced by Soken Chemical & Engineering Co., Ltd.) of 10 g, whose average particle diameter was 2 μm, were added to the added solution, and this mixture was stirred to disperse the crosslinked polystyrene particles with a high speed stirrer for an hour. The stir speed thereof was 5000 rpm. Thereafter, the filtration of the dispersed solution was made with a polypropylene filter having pores whose diameter each was 30 μm. Then the coating solution A for antiglare layer was obtained.

(Preparation of Coating Solution B for Antiglare Layer)

A mixture solvent containing cyclohexanone of 24 g and methylethyl ketone 24 g was stirred with an air stirrer. Thereby to the mixture solvent were added a coating solution for hard coat that contains DeSolite Z-7401 (containing zirconium oxide dispersion, and produced by JSR corporation) of 218 g, KAYARAD DPHA (produced by NIPPON KAYAKU CO., LTD.) of 91 g, and IRGACURE (produced by Chiba Gaigy Japan Limited) of 10 g. Thus an added solution was obtained. Then it was coated and thereafter cured with ultraviolet ray to obtain a coating layer, which had refractive index of 1.61. Further, crosslinked polystyrene particles (name of product: SX-200H, produced by Soken Chemical & Engineering Co., Ltd.) of 5 g, whose average particle diameter was 2 μm, were added to the added solution, and this mixture was stirred to disperse the crosslinked polystyrene particles with a high speed stirrer for an hour. The stir speed thereof was 5000 rpm. Thereafter, the filtration of the dispersed solution was made with a polypropylene filter having pores whose diameter each was 30 μm. Then the coating solution B for antiglare layer was obtained.

(Preparation of Coating Solution C for Antiglare Layer)

In order to prepare a coating solution C for an antiglare layer, Methylethyl ketone and cyclohexanone were mixed in ratio of 54 wt. % and 46 wt. % for using as the solvent. Further, a mixture (DPHA, produced by NIPPON KAYAKU CO., LTD.) was used, in which dipentaerythritol pentaacrylate and dipentaerythritol hexaacrylate were mixed. The solvent of 52 g was supplied with 91 g of the mixture, 218 g of hard coat solution containing zirconium oxide (DeSolite Z-7401, produced by JSR corporation), and 19 g of hard coat solution containing zirconium oxide (DeSolite KZ-7161, produced by JSR corporation). Thus the mixture was dissolved to obtain a mixed solution. Then in the mixed solution was dissolved a photo polymerization initiator (IRGACURE 907, produced by Chiba Gaigy Japan Limited) of 10 g to obtain an added solution. The added solution was coated and thereafter cured with ultraviolet ray to obtain a coating layer, which had refractive index of 1.61. Further, crosslinked polystyrene particles (name of product: SX-200H, produced by Soken Chemical & Engineering Co., Ltd.) of 20 g, whose average particle diameter was 2 μm, were added to a mixture solvent of 80 g, in which methylethylketone of 54 wt. % and cyclohexanone of 46 wt. % were mixed. This solution was stirred to disperse the crosslinked polystyrene particles with high speed stirrer of 5000 rpm for an hour, and added to the added solution to obtain the dispersed solution. Thereafter, the filtration of the dispersed solution was made with a polypropylene filter having pores whose diameter each was 30 μm. Then the coating solution C for antiglare layer was obtained.

(Preparation of Coating Solution D for Hard Coating)

In order to prepare a coating solution D for a hard coating, methylethylketone of 62 g and cyclohexanone of 88 g were mixed for using as the solvent. Then, UV-ray curable hard coat composition (DeSolite Z-7526, 72 wt. %, produced by JSR corporation) of 250 g was dissolved to the solvent. This obtained solution was coated and cured in ultraviolet ray to form a coating layer, which had refractive index of 1.53. Further, the solution was filtrated with a polypropylene filter having pores whose diameter each was 30 μm. Then the coating solution D for hard coating layer was obtained.

(Preparation of Coating Solution E for Low Reflective Index Layer)

MEK-ST of 8 g (average diameter of particles was 10 nm-20 nm, SiO₂ sol dispersion of methylethylketone, whose solids content degree was 30 wt. %, produced by Nissan Chemical Industries Co., Ltd.) and methylethylketone of 100 g were added to heat-closslinkage polymer (TN-049, produced by JSR Corporation) of 20093 g containing fluoride that had refractive index of 1.42. This mixture was stirred and filtrated with a polypropylene filter having pores whose diameter was 1 μm. Thus the coating solution E for low refractive index layer was obtained.

A surface of the cellulose triacetate film of 80 μm thickness that was produced in Experiment 1 of Example 2 was coated with the coating solution D by using a bar coater, and thereafter dried at 120° C. Then an UV light was applied to the coating layer on the film with air-cooled type metal halide lamp of 160 W/cm (produced by Eyegraphics Co., Ltd.). The illuminance was thereby 400 mW/cm², and illumination density was 300 mJ/cm². Thus the coating was cured to form the hard coat layer of thickness of 2.5 μm on the film. Further, the coating solution A was applied on the hard coat layer on the film with the bar coater. The coating solution A was dried and cured in the same conditions as in forming the hard coat layer (namely in application of UV light). Thus the antiglare layer A of 1.5 μm was formed. Furthermore, the antiglare layer A was coated with the coating solution E for the low refractive index layer. Furthermore the coating solution E for the low reflective index layer was applied on the antiglare layer A and dried at 80° C. Then the cross-linking was made at 120° C. for ten minutes to form a low refractive index layer whose thickness was 0.096 μm. Thus an antireflection film is obtained.

As another experiment, an antireflection film is obtained by applying the process as described above to the film of Experiment 1, except the coating solution B is used instead of the coating solution A. As further another experiment, an antireflection film is obtained by the same process as described above, except the coating solution C is used instead of the coating solution A. In addition, other antireflection films are obtained by coating each of the coating solutions A, B, C on each of the films of Experiment 2 to Experiment 6, in the above-described conditions. The estimations of the obtained antireflection films were made as follows. The results are shown in Table 1.

(1) Specular Reflectance and Integral Reflectance.

A spectrophotometer V-550 (produced by JASCO Corporation) was provided with an adapter ARV-474 to measure the specular reflectance at an exiting angle of −5° according to the incident light of wavelength from 380 nm to 780 nm at the incident angle of 5°. Then the average of the specular reflectance of the reflection whose wavelength was from 450 nm to 650 nm was calculated to evaluate properties of antireflection. Actually, when the specular reflectance was at most 5%, there was no problem, actually. Further, a spectrophotometer V-550 (produced by JASCO Corporation) was provided with an adapter ILV-471 to measure the integral reflectance according to the incident light of wavelength between 380 nm and 780 nm at the incident angle of 5°. Then the average of the integral reflectance of the reflection whose wavelength was between 450 nm and 650 nm was calculated to evaluate antireflection properties. When the integral reflectance was at most 10%, there was no problem, actually.

(2) Haze

A haze meter MODEL 1001 DP, (produced by Nippon Denshoku Industries Co., Ltd.) was used for measurement of haze of the antireflection film. When the haze was at most 15%, there was no problem, actually.

(3) Pencil Hardness

The evaluations of pencil hardness were made as described in JIS K 5400 and the data thereof was used as a criterion of scratch resistance. After the antireflection film was set in atmosphere with the temperature of 25° C. and the humidity of 60% RH for two hours, the surface of the antireflection film was scratched with a 3H test pencil determined in JIS S 6006. Thereby a force of 1 kg was applied to the test pencil. The evaluation of the pencil hardness was:

“A”, when no scratch remains on the surface in evaluation of n=5 (n was trial number of performances of scratching);

“B”, when one or two scratches remained on the surface in evaluation of n=5;

“N”, when more than two scratches remain on the surface in evaluation of n=5.

(4) Contact Angle

After the antireflection film was set in the atmosphere at 25° C. and the humidity of 60% RH for two hours, the contact angle to the water on the antireflection film was measured, and the data thereof was used as a criterion of antistaining, especially finger printing stain proofness. Actually, when the contact angle was in the range of 90° to 180°, there were no problems.

(5) Color Tint

A reflection spectrum was obtained from a data of the observation. Then from the reflection spectrum were calculated L* number, a* number and b* number in a CIE 1976 L*a*b* space, which represent the color tint of the regular reflection to a light generated with an incident angle at 5° by a CIE standard light source D65. The color tint was estimated on the basis of the L* number, a* number and b* number. Actually, there were no problems when the L* number, a* number and b* number are respectively 0 to +15, 0 to +20, and −30 to 0.

(6) Coefficient of Dynamic Friction

After the antireflection film was set in the atmosphere with the temperature of 25° C. and the relative humidity of 60% for two hours, the coefficient of dynamic friction was measured with a machine for measuring the coefficient of dynamic friction, HEIDON-14, in which a stainless steel ball of 5 mmφ was used. Thereby, the speed was set to 60 cm/min, and a force of 100 gf was applied to the surface of the antireflection film. When the coefficient of dynamic friction was at most 0.15, there was no problem, actually.

(7) Antiglare Property

An fluorescent lamp (8000 cd/m²) without louver emitted a light onto each antireflection film and the light reflects. An image of the fluorescent lamp formed by the reflection was observed. Thus the estimation of antiglare property was made as follows:

“E” (Excellent) when no outline of the illumination lamp was observed;

“G” (Good) when the outline was slightly recognized;

“P” (Pass) when the outline was not clear but recognized;

“R” (Reject) when the outline was almost clear.

(8) Evaluation of Surface Condition of Coating Layer

A surface of the coating layer of each antireflection film was observed with eyes, and the estimation was made as follows:

“E” (Excellent) when the surface of the coating layer is smooth;

“G” (Good) when the surface is smooth but there were little impurities;

“P” (Pass) when the surface is slightly uneven, and the impurities are observed clearly;

“R” (Reject) when the surface is uneven and there is a large number of the impurities.

TABLE 1

| | | SR | IR | HZ | PH | CA | Color Tint | CDF | |
|---|---|---|---|---|---|---|---|---|---|
| Film | AL | (%) | (%) | (%) | (3H) | (°) | L*/a*/b* | (−) | AP |
| Ex. 1 | A | 1.1 | 2.0 | 8 | A | 103 | 10/1.9/1.3 | 0.08 | E |
| | B | 1.1 | 2.0 | 8 | A | 102 | 9/2.0/−4.0 | 0.09 | E |
| | C | 1.1 | 2.0 | 12 | A | 102 | 9/1.7/0.2 | 0.08 | E |
| Ex. 2 | A | 1.1 | 2.0 | 8 | A | 103 | 10/1.9/1.3 | 0.08 | E |
| | B | 1.1 | 2.0 | 8 | A | 102 | 9/2.0/−4.0 | 0.09 | E |
| | C | 1.1 | 2.0 | 12 | A | 102 | 9/1.7/0.2 | 0.08 | E |
| Ex. 3 | A | 1.1 | 2.0 | 8 | A | 103 | 10/1.9/1.3 | 0.08 | E |
| | B | 1.1 | 2.0 | 8 | A | 102 | 9/2.0/−4.0 | 0.09 | E |
| | C | 1.1 | 2.0 | 12 | A | 102 | 9/1.7/0.2 | 0.08 | E |
| Ex. 4 | A | 1.1 | 2.0 | 8 | A | 103 | 10/1.9/1.3 | 0.08 | E |
| | B | 1.1 | 2.0 | 8 | A | 102 | 9/2.0/−4.0 | 0.09 | E |
| | C | 1.1 | 2.0 | 12 | A | 102 | 9/1.7/0.2 | 0.08 | E |
| Ex. 5 | A | 1.1 | 2.0 | 8 | A | 103 | 10/1.9/1.3 | 0.08 | E |
| | B | 1.1 | 2.0 | 8 | A | 102 | 9/2.0/−4.0 | 0.09 | E |
| | C | 1.1 | 2.0 | 12 | A | 102 | 9/1.7/0.2 | 0.08 | E |
| Ex. 6 | A | 1.1 | 2.0 | 8 | A | 103 | 10/1.9/1.3 | 0.08 | E |
| | B | 1.1 | 2.0 | 8 | A | 102 | 9/2.0/−4.0 | 0.09 | E |
| | C | 1.1 | 2.0 | 12 | A | 102 | 9/1.7/0.2 | 0.08 | E |

AL: antiglare layer
SR: specular reflectance
IR: integral reflectance
HZ: haze
PH: pencil hardness
CA: contact angle
CDF: coefficient of dynamic friction
AP: antiglare property

According to the result of experiments shown in Table 1, it is clear that the antireflection film, which is one of the optical film formed with the use of the film obtained by the dope produced by the method of the present invention, has superior antiglare and antireflection properties, muted colors, and superior other film properties such as pencil hardness, finger printing stain proofness and coefficient of dynamic friction.

[Producing and Evaluating a Polarizing Film]

A polarizer is produced by stretching polyvinyl alcohol film and absorbing iodine on the polyvinyl alcohol, and each of the films obtained from Experiment 1 to 6 is adhered on both faces of the polarizer with use of polyvinyl alcohol type adhesive, then the polarizing filter is obtained. The polarizing filter is exposed for 500 hours in an atmosphere of 60° C., 90% RH.

According to the obtained polarizing filter, a parallel transmittance Yp and a crossed transmittance Yc in the visible range was obtained with a spectrophotometer, and the polarizing coefficient P was calculated on the basis of the following formula:

P={(Yp−Yc)/(Yp+Yc)}^{1/2}×100(%)

Each of the polarizing filter having the film produced from one of Experiment 1 to 6 has polarization degree of 99.6% or more and sufficient durability. Therefore, the film formed by casting the dope produced by the apparatus of the present invention can be preferably used as the protective film of the polarizing filter, and this polarizing filter has excellent optical properties.

Next, an antiglare-antireflection polarizing filter, which has an antireflection layer as a surface layer, was formed with use of the film produced from one of Experiment 1 to 6. When the antiglare-antireflection polarizing filter was used for a liquid crystal display, the liquid crystal display has superior contrast because the antiglare property prevents reflection of outside light, superior visibility because the antireflection property prevents a reflection image being highly visible, and superior finger printing stain proofness. Therefore, the film formed by casting the dope produced by the apparatus of the present invention has superior properties as the optical film, and the film can be preferably used for a component of the liquid crystal display.

### INDUSTRIAL APPLICABILITY

The apparatus for producing dope of the present invention can be preferably used for dissolving solutes having poor solubility in solvents to obtain a solution.

1. An apparatus for producing dope having a heat transfer device for transferring heat to a dope including a polymer and a solvent so as to control a temperature of said dope, said heat transfer device comprising:
a cylinder whose size is defined by JIS standard, which controls said temperature of said dope passing through inside said cylinder; and
flanges attached to both ends of said cylinder, whose size is larger than a size defined by JIS standard corresponding to said size of said cylinder.

2. An apparatus for producing dope described in claim 1, wherein said heat transfer device further comprises a pressurizer for pressurizing inside of said cylinder 0.05 MPa or more from atmospheric pressure.

3. An apparatus for producing dope described in claim 1, wherein said heat transfer device further comprises:
a jacket surrounding around said an outer peripheral surface of said cylinder; and
a passage formed between said jacket and said cylinder, in which heating medium flows for controlling a temperature of said cylinder, and whose each end being positioned within 5 cm from an opposite surface of said each flange to a surface on which said cylinder is attached.

4. An apparatus for producing dope described in claim 1, wherein said heat transfer device includes a vacuum insulation member provided on said outer peripheral surface of said cylinder.

5. An apparatus for producing dope described in claim 1, wherein said cylinder has an inner peripheral surface whose roughness average (Ra) is in a range of 0.1 μm to 50 μm.

6. An apparatus for producing dope described in claim 1, wherein said heat transfer device further comprises a jacketed valve for controlling a flow rate of said dope passing out from said cylinder.

7. An apparatus for producing dope described in claim 1, wherein said heat transfer device is used in preparing, transferring or preserving said dope.

8. An apparatus for producing dope having a heat transfer device for transferring heat to a dope including a polymer and a solvent so as to control a temperature of said dope, said heat transfer device comprising:
a container for controlling said temperature of said dope therein; and
a pressurizer for pressurizing inside of the container 0.05 MPa or more from atmospheric pressure.

9. An apparatus for producing dope described in claim 8, wherein said heat transfer device further comprises:
a jacket covering said an outer surface of said container; and
a passage formed between said jacket and said container, in which heating medium flows for controlling a temperature of said container.

10. An apparatus for producing dope described in claim 8, wherein said heat transfer device includes a vacuum insulation member provided on an outer surface of said container.

11. An apparatus for producing dope described in claim 8, wherein said container has an inner surface whose roughness average (Ra) is in a range of 0.1 μm to 50 μm.

12. An apparatus for producing dope described in claim 8, wherein said heat transfer device further comprises a jacketed valve for releasing said dope from said container with controlling a flow rate of said dope.

13. An apparatus for producing dope described in claim 8, wherein said heat transfer device is used in preparing, transferring or preserving said dope.
